(19) United States
(12) Patent Application Publication
(10) Pub. No.: US 2017/0371953 A1
(43) Pub. Date: Dec. 28, 2017

(54) SEARCH SYSTEM EMPLOYING RESULT FEEDBACK

(71) Applicant: eBay Inc., San Jose, CA (US)

(72) Inventors: Debasree Kanjilal, Bengaluru (IN); Ruchirbhai Rajendra Shah, Bengaluru (IN); Vijay Samuel Vaseeharan Alexander, San Jose, CA (US); Sankaranarayanan Venkatraman, Bengaluru (IN); Ramachandran Ramesh, Bengaluru (IN)

(21) Appl. No.: 15/189,558

(22) Filed: Jun. 22, 2016

(51) Int. Cl. G06F 17/30

(52) U.S. Cl. CPC G06F 17/30648; G06F 17/30696; G06F 17/30867

(57) ABSTRACT

In various example embodiments, a search system and method employing search result feedback are presented. In an example, a search system may include a listing database including a plurality of listings, and a search engine may generate first search results in response to a first search query, the first search results including one or more of the plurality of listings. A search results modifier may receive a selection of a first listing of the first search results, with the selection of the first listing indicating a lack of interest in the first listing. The search engine may generate second search results in response to a second search query subsequent to the first search query, wherein the second search results include the first listing. The search results modifier may modify the second search results to less prominently display the first listing in the second search results.

### TECHNICAL FIELD

Embodiments of the present disclosure relate generally to data processing and, more particularly, but not by way of limitation, to search systems that employ search result feedback.

### BACKGROUND

General web search websites (e.g., those provided by Google Inc. and Yahoo! Inc.), as well as other types of search engines that are more specifically focused on particular types of items, documents, and so on, have become more sophisticated in interpreting user search queries to provide search results that are more closely aligned with the expectations of the user. However, regardless of the effectiveness of the search engine, or the specificity with which the user crafts search queries, the odds of at least some of the search results being of little or no interest to the user remain quite high. Given the generally limited amount of display space typically provided on device displays, especially those employed in smart phones, tablet devices, and the like, the presence of unwanted listings in search results tends to reduce the visibility of other, more desirable listings from the perspective of the user by forcing such listings toward a less prominent area of the display, or onto a subsequent page of search results entirely.

### BRIEF DESCRIPTION OF THE DRAWINGS

Various ones of the appended drawings merely illustrate example embodiments of the present disclosure and cannot be considered as limiting its scope.

FIG. 1 is a block diagram of an example communication system including an example search system employing search result feedback.

FIG. 2 is a block diagram of an example networked system incorporating at least a portion of the example search system of FIG. 1.

FIG. 3 is a flow diagram of an example method of employing search result feedback to modify search results presented in response to search queries.

FIG. 4 is a flow diagram of an example method of employing search result feedback to provide feedback to a listing entity.

FIG. 5A depicts an example search device presenting search results in response to a search query.

FIG. 5B depicts the example search device of FIG. 5A while search result feedback is being provided.

FIG. 5C depicts the example search device of FIG. 5A presenting search results subsequent to the search result feedback of FIG. 5B.

FIG. 6 is a block diagram illustrating an example of a software architecture that may be installed on a machine, according to some example embodiments.

FIG. 7 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

In the following description, for the purposes of explanation, numerous specific details are set forth in order to provide an understanding of various example embodiments of the present subject matter. It will be evident, however, to those skilled in the art, that example embodiments of the present subject matter may be practiced without these specific details.

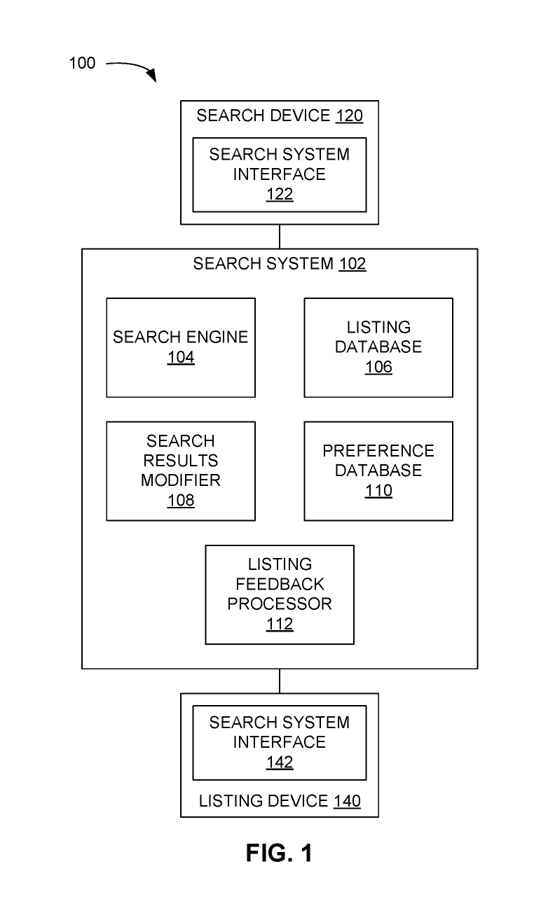

FIG. 1 is a block diagram of an example communication system 100 including a search system 102 communicatively coupled with a search device 120 and a listing device 140. In other example embodiments, there may be multiple instances of the search system 102, the search device 120, and/or the listing device 140, but only one of each of these components is depicted in FIG. 1 to focus and simplify the following discussion. Generally, the listing device 140 operates to provide one or more listings for items (e.g., physical items, services, documents, photographs, songs, webpages, etc.) that are searchable via the search system 102, while the search device 120 operates to provide one or more search queries to the search system 102 to find desired listings. In response, the search 102 may provide zero or more search results to each search query received from the search device 120. In some examples, a single device may serve as both the search device 120 and the listing device 140, at least from time to time. Examples of the search device 120 and the listing device 140 may include, but are not limited to, desktop computers, laptop computers, tablet computers, smart phones, television set-top boxes, television streaming devices, and gaming systems.

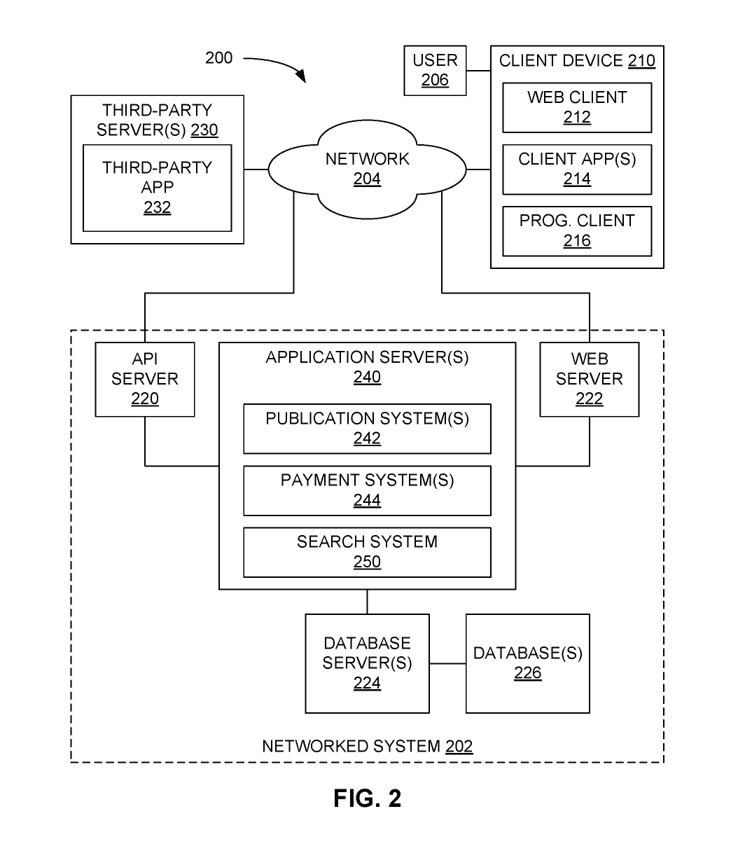

As depicted in FIG. 1, the search device 120 includes a search system interface 122, while the listing device 140 includes a search system interface 142. Examples of the search system interfaces 122, 142 may include communication interfaces, such as interfaces for a wide area network (WAN) (e.g., the Internet), a wireless WAN (WWAN), a local area network (LAN), a wireless LAN (WLAN), a virtual private network (VPN), a cell phone data network (e.g., a 3G or 4G network), another type of network, or a combination of two or more such networks. Such interfaces may be employed using, for example, web browsers, dedicated programmatic applications (e.g., “apps”), and the like. Each of the search device 120 and the listing device 140 may include various other components, such as those discussed more fully below in conjunction with FIGS. 2, 6, and 7.

The search system 102 may include one or more modules, such as a search engine 104, a listing database 106, a search results modifier 108, a preference database 110, and a listing feedback processor 112. In other examples, the search system 102 may include fewer modules than those shown in FIG. 2, may combine one or more such modules, and/or may include additional modules not specifically described herein. In one example, the search system 102 may be a server or portion thereof that is accessible by one or more communication networks, such as those mentioned above. In yet other example embodiments, the search system 102, the search device 120, and/or the listing device 140 may be combined into a single computing device or system. In other examples, one or more of the modules 104-112 may be employed with in the search device 120 and/or the listing device 140 instead of, or in addition to, the search system 102.

The listing database 106 may include a plurality of listings, with each listing representing a particular item, such as a document, webpage, object, service, or other item of interest. In some example embodiments, each listing may be associated with one or more keywords, labels, parameters, or other terms that are descriptive of the item or are otherwise related to the item in some manner. Such terms may indicate, for example, a subject or category identified with the item, a title or name of the item, an entity (e.g., a vendor, distributor, contributor, composer, author, etc.) related to the item, and/or some characteristic (e.g., size, color, cost, function, etc.) associated with the item. The listings of the listing database 106, as well as any or all information within each listing, may be created or generated via one or more listing devices 140, possibly using input forms or other input methods provided by the search system 102 or another system.

The listings of the listing database 106 may be organized according to any format, such as a relational database format, an object database format, a knowledge base format, a data warehouse format, and so on. The listing database 106 may also include a database management system (not explicitly shown in FIG. 1) that controls or performs the storing, deletion, modification, and/or access of the listings of the listing database 106.

The search engine 104 may receive a search query from the search device 120, and search the listing database 106 for listings based on the search query. In one example, the search query may include one or more terms, such as words, phases, or other collections of alphanumeric characters and other specialized characters. In some example embodiments, the search engine 104 may generate or calculate a score or other value representing a level of correlation between the terms of the search query and the terms associated with each of a plurality of the listings in the listing database 106. The value may be determined according to any number of rules, rubrics, algorithms, equations, and so on. For example, the value associated with a listing may depend on how closely each of the terms of the search query relate to the terms of that listing.

Based on the generated values, the search engine 104 may provide zero or more search results for presentation via the search device 120. In various example embodiments, the search engine 104 may present multiple listings in the search results, arranged or ordered according to their associated correlation values. For example, the listings with the highest values may be presented more prominently or visibly in the search results than listings with relatively lower values. In some implementations, only listings with values that meet or exceed some threshold value may be provided in the search results for presentation via the search device 120.

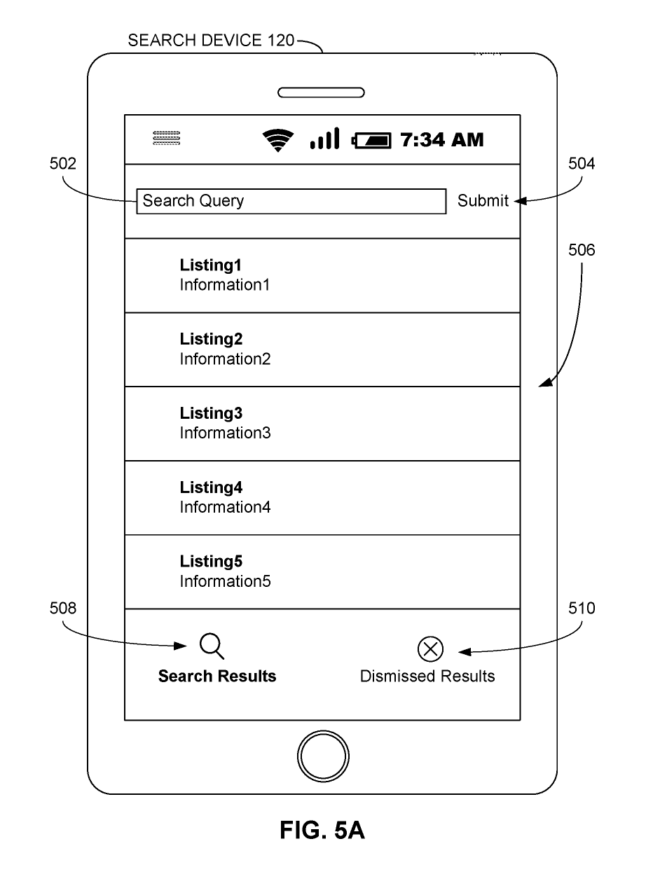

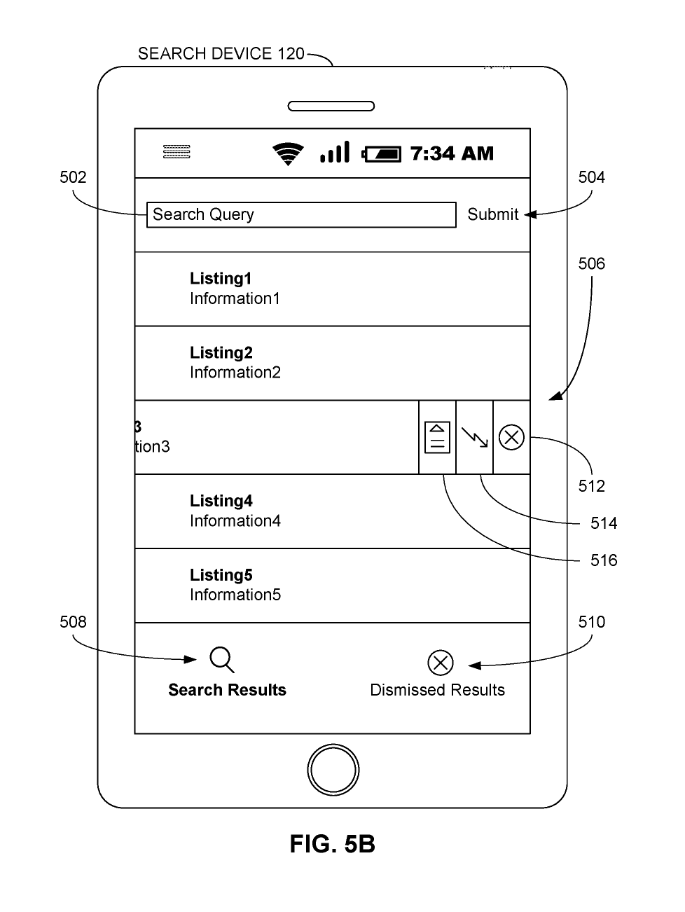

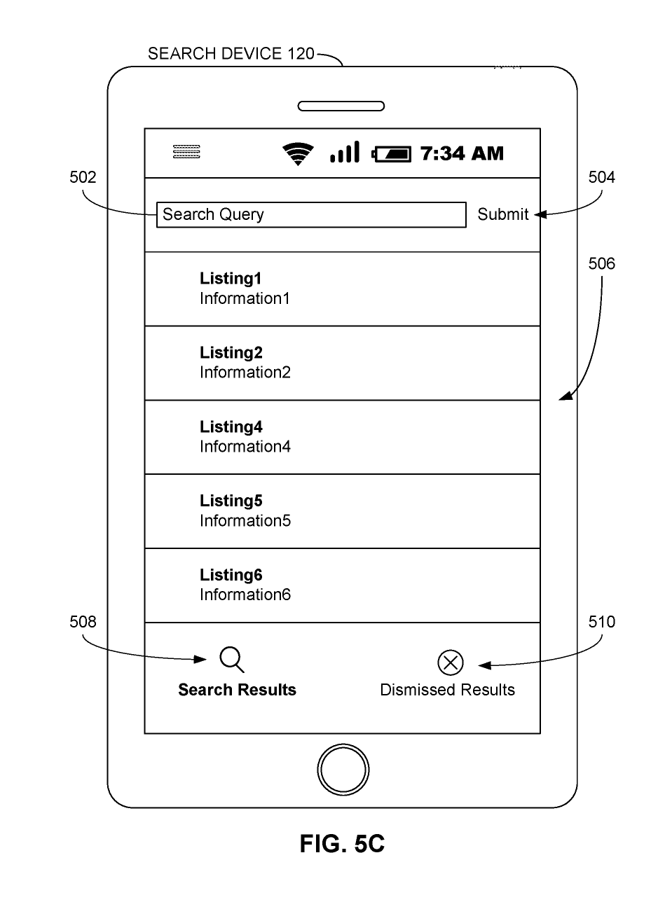

The search results modifier 108 may receive feedback from the search device 120 regarding the search results. For example, a user of the search device 102 may select one or more listings to be dismissed, omitted, or removed from the search results as presented, or demoted to a less prominent position within the search results as presented. In response to the feedback, the search results modifier 108 may alter the search results, or alter the presentation of the search results via the search device 120, to remove, dismiss, or demote the listing selected by the user. FIGS. 5A, 5B, and 5C, discussed below, provide just one example of a dismissed listing. In other examples, the search results modifier 108 may remove, dispense, or demote other listings in the search results that are similar to the listing selected by the user.

The search results modifier 108 may also record one or more aspects of the received feedback in the preference database 110 to modify subsequent search queries from the same user or other entity associated with the original search query. In one example, the search results modifier 108 may store indications of the particular listings that the user has dismissed or demoted in search results. In other example embodiments, the search results modifier 108 may associate each recorded dismissed or demoted listing with an indication of the search query corresponding to the recorded listing. In some examples, the search results modifier 108 may record other information in addition to, or in lieu of, the dismissed or demoted listing, such as, for example, user preferences indicating particular characteristics of listings that are to be demoted or dismissed without a preceding selection of a listing to be dismissed or demoted, and thereafter employ that information to automatically demote or dismiss listings related to the particular listing characteristics selected.

The search result modifier 108, in response to subsequent search results generated by the search engine 104, may then access the preference database 110 to determine whether any of the listings of the currently generated search results have been recorded in the preference database 110. If any of these listings have been recorded in the preference database 110, the search result modifier 108 may remove those listings from the current search results, or demote those listings within the current search results, before the search engine presents the search results via the search device 120. In another example embodiment, the search result modifier 108 may compare the search query corresponding to the current search results to a previous search query indicated in the preference database 110 to identify one or more dismissed or demoted listings associated with that previous search query. The search result modifier 108 may then dismiss the identified listings from the search results to be presented, or demote the identified listings in the search results to be presented, prior to presenting the current search results via the search device 120.

In some example embodiments, the search results modifier 108 may identify other listings of search results generated by the search engine 104 that are closely related to dismissed or demoted listings identified in the preference database 110 in response to previous search queries, or dismissed or demoted listings selected in the current search results by the user via the search device 120. For example, the search results modifier 108 may dismiss or demote listings for items similar in some way to items corresponding to listings that have been previously dismissed or demoted, as indicated in the preference database 110.

As with the listing database 106, the preference database 110 may be organized according to any format, such as a relational database format, an object database format, a knowledge base format, a data warehouse format, and so on. The preference database 110 may also include a database management system (not explicitly shown in FIG. 1) that controls or performs the storing, deletion, modification, and/or access of the listings of the preference database 110.

The listing feedback processor 112 may also receive an indication of one or more listings selected by the user by the search device 120 for dismissal or demotion in the search results, possibly along with information supplied by the user via the search device 120 as to why the listing was demoted or dismissed. In response to that information, the listing feedback processor 112 may record the supplied information in conjunction with the dismissed or demoted listing. In addition, the listing feedback processor 112 may facilitate access to the selected listing and the recorded information to one or more entities associated with the listing device 140. The entity may consider such information as useful feedback. For example, the entity may employ such information provided by the user, as well as information provided by other users, to modify the demoted or dismissed listing in the listing database 106 to make the listing more attractive to users, or to remove the listing from the listing database 106. In some examples, the information supplied by the user may be textual or graphical in nature, or be represented in some other format.

With reference to FIG. 2, an example embodiment of a high-level client-server-based network architecture 200 is shown. A networked system 202, in the example forms of a network-based marketplace or payment system, provides server-side functionality via a network 204 (e.g., the Internet or wide area network (WAN)) to one or more client devices 210. FIG. 2 illustrates, for example, a web client 212 (e.g., a browser, such as the Internet Explorer® browser developed by Microsoft® Corporation of Redmond, Washington State), an application 214, and a programmatic client 216 executing on client device 210.

The client device 210 may comprise, but are not limited to, a mobile phone, desktop computer, laptop, portable digital assistants (PDAs), smart phones, tablets, ultrabooks, netbooks, laptops, multi-processor systems, microprocessor-based or programmable consumer electronics, game consoles, set-top boxes, or any other communication device that a user may utilize to access the networked system 202, and may serve as the search device 120 and/or the listing device 140 of FIG. 1. In some example embodiments, the client device 210 may comprise a display module (not shown) to display information (e.g., in the form of user interfaces). In further example embodiments, the client device 210 may comprise one or more of a touch screens, accelerometers, gyroscopes, cameras, microphones, global positioning system (GPS) devices, and so forth. The client device 210 may be a device of a user that is used to perform a transaction involving digital items within the networked system 202. In one example embodiment, the networked system 202 is a network-based marketplace that responds to requests for product listings, publishes publications comprising item listings of products available on the network-based marketplace, and manages payments for these marketplace transactions. One or more users 206 may be a person, a machine, or other means of interacting with client device 210. In example embodiments, the user 206 is not part of the network architecture 200, but may interact with the network architecture 200 via client device 210 or another means. For example, one or more portions of network 204 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMAX network, another type of network, or a combination of two or more such networks.

Each of the client device 210 may include one or more applications (also referred to as “apps”) such as, but not limited to, a web browser, messaging application, electronic mail (email) application, an e-commerce site application (also referred to as a marketplace application), and the like. In some example embodiments, if the e-commerce site application is included in a given one of the client device 210, then this application is configured to locally provide the user interface and at least some of the functionalities with the application configured to communicate with the networked system 202, on an as-needed basis, for data and/or processing capabilities not locally available (e.g., access to a database of items available for sale, to authenticate a user, to verify a method of payment, etc.). Conversely if the e-commerce site application is not included in the client device 210, the client device 210 may use its web browser to access the e-commerce site (or a variant thereof) hosted on the networked system 202.

One or more users 206 may be a person, a machine, or other means of interacting with the client device 210. In example embodiments, the user 206 is not part of the network architecture 200, but may interact with the network architecture 200 via the client device 210 or other means. For instance, the user provides input (e.g., touch screen input or alphanumeric input) to the client device 210 and the input is communicated to the networked system 202 via the network 204. In this instance, the networked system 202, in response to receiving the input from the user, communicates information to the client device 210 via the network 204 to be presented to the user. In this way, the user can interact with the networked system 202 using the client device 210.

An application program interface (API) server 220 and a web server 222 are coupled to, and provide programmatic and web interfaces respectively to, one or more application servers 240. The application servers 240 may host one or more publication systems 242, payment systems 244, and search system 250, each of which may comprise one or more modules or applications and each of which may be embodied as hardware, software, firmware, or any combination thereof. The application servers 240 are, in turn, shown to be coupled to one or more database servers 224 that facilitate access to one or more information storage repositories or database(s) 226. In an example embodiment, the databases 226 are storage devices that store information to be posted (e.g., publications or listings) to the publication system 242. The databases 226 may also store digital item information in accordance with example embodiments.

Additionally, a third party application 232, executing on third party server(s) 230, is shown as having programmatic access to the networked system 202 via the programmatic interface provided by the API server 220. For example, the third party application 232, utilizing information retrieved from the networked system 202, supports one or more features or functions on a website hosted by the third party. The third party website, for example, provides one or more promotional, marketplace, or payment functions that are supported by the relevant applications of the networked system 202.

The publication systems 242 may provide a number of publication functions and services to users 206 that access the networked system 202. The payment systems 244 may likewise provide a number of functions to perform or facilitate payments and transactions. While the publication system 242 and payment system 244 are shown in FIG. 2 to both form part of the networked system 202, it will be appreciated that, in alternative example embodiments, each system 242 and 244 may form part of a payment service that is separate and distinct from the networked system 202. In some example embodiments, the payment systems 244 may form part of the publication system 242.

The search system 250 may serve as the search system 102 of FIG. 1. More specifically, the search system 250 may operate as a search system for items to be sold by way of the networked system 202. In some example embodiments, the search system 250 may communicate with the publication systems 242 (e.g., accessing item listings) and payment system 244. In an alternative example embodiment, the search system 250 may be a part of the publication system 242.

Further, while the client-server-based network architecture 200 shown in FIG. 2 employs a client-server architecture, the present inventive subject matter is of course not limited to such an architecture, and could equally well find application in a distributed, or peer-to-peer, architecture system, for example. The various publication system 242, payment system 244, and search system 250 could also be implemented as standalone software programs, which do not necessarily have networking capabilities.

The web client 212 may access the various publication and payment systems 242 and 244 via the web interface supported by the web server 222. Similarly, the programmatic client 216 accesses the various services and functions provided by the publication and payment systems 242 and 244 via the programmatic interface provided by the API server 220. The programmatic client 216 may, for example, be a seller application (e.g., the Turbo Lister application developed by eBay® Inc., of San Jose, California) to enable sellers to author and manage listings on the networked system 202 in an off-line manner, and to perform batch-mode communications between the programmatic client 216 and the networked system 202.

Additionally, a third party application(s) 232, executing on a third party server(s) 230, is shown as having programmatic access to the networked system 202 via the programmatic interface provided by the API server 220. For example, the third party application 232, utilizing information retrieved from the networked system 202, may support one or more features or functions on a website hosted by the third party. The third party website may, for example, provide one or more promotional, marketplace, or payment functions that are supported by the relevant applications of the networked system 202.

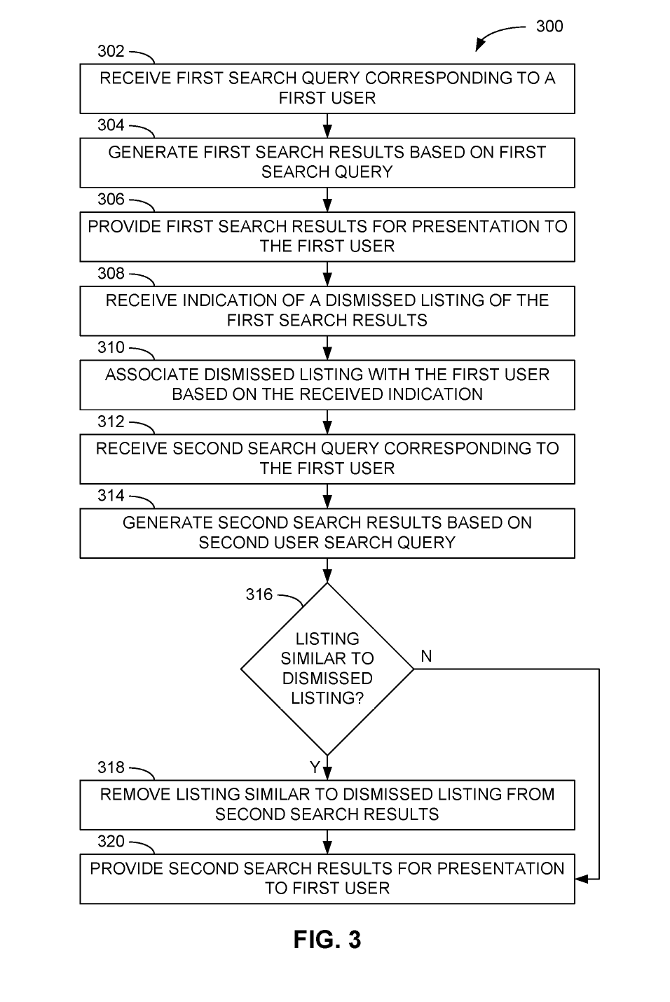

FIG. 3 is a flow diagram of an example method 300 of employing search result feedback to modify search results presented in response to search queries. While execution of the method 300, as well as other methods discussed herein, is described in conjunction with the search system 102 of FIG. 1 and/or the search system 250 of FIG. 2, other systems or devices not specifically described herein may be employed to perform the method 300 in other examples. Also, while the operations of the methods discussed below are presented in a particular order, other orders of operation, including concurrent or simultaneous execution of the operations, are also possible.

In the method 300, a search engine (e.g., the search engine 104 of FIG. 1) may receive a first search query corresponding to a first user (operation 302). The search engine may generate first search results based on the first search query (operation 304). The search engine may then provide the first search results for presentation to the first user (operation 306). In one example, the first search results include zero or more listings from a listing database (e.g., the listing database 106 of FIG. 1). The search engine may then provide the first search results for presentation to the first user (operation 306). A search results modifier (e.g., the search results modifier 108 of FIG. 1) may receive an indication of at least one dismissed or demoted listing of the first search results (operation 308). In some examples, the search results modifier may modify the first search results by dismissing or demoting the indicated listings, and providing the modified first search results for presentation to the first user.

Continuing with the method 300, the search results modifier may associate the dismissed listing with the first user based on the received indication (operation 310). In some examples, this association may be recorded in a preference database (e.g., the preference database 110 of FIG. 1). The search engine may receive a second search query corresponding to the first user (operation 312). Based on the second search query, the search engine may generate second search results (operation 314). The search results modifier may compare the second search results to at least one dismissed or demoted listing associated with the first user (operation 316). If one or more of the second search results is the same as the at least one dismissed or demoted listing (operation 316), the search results modifier may remove the at least one dismissed or demoted listing from the second search results (operation 318). The search results modifier may provide the modified second search results for presentation to the first user (operation 320). In some example embodiments, the search results modifier may remove or demote one or more listings from the second search results based on the one or more listings being similar to at least one dismissed or demoted listing associated with the first user (operation 316), and then remove or demote the similar listings from the second search results (operation 318). In various examples, the search results modifier may modify search results associated with subsequent search queries as well.

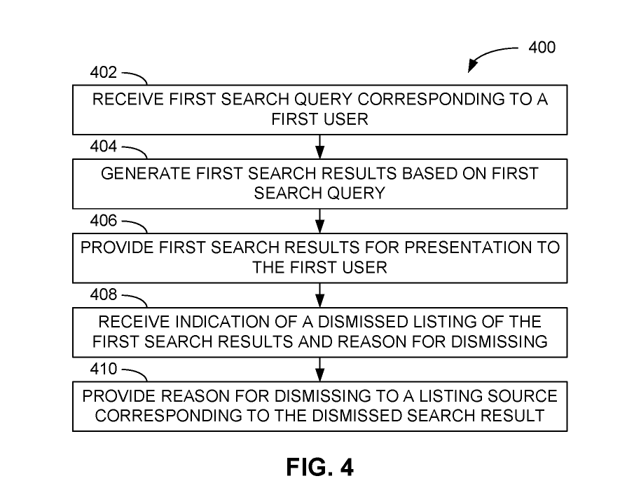

FIG. 4 is a flow diagram of an example method 400 of employing search result feedback to provide feedback to a listing entity. In the method 400, operations 402 through 406 (e.g., the reception of a first search query corresponding to a first user, the generation of the first search results, and the providing of the first search results for presentation to the first user) may correspond to operations 302 through 306 of FIG. 3, as described above. A search results modifier (e.g., the search results modifier 108 of FIG. 1) may receive an indication of at least one dismissed or demoted listing of the first search results (operation 408) in a manner similar to that of operation 408 of FIG. 1. In addition, a listing feedback processor (e.g., the listing feedback processor 112 of FIG. 1) may receive or access a reason for a listing being dismissed or demoted from the first search results (operation 408). Such a reason may be provided explicitly or implicitly by the first user in some example embodiments. In response, the listing feedback processor may provide, or facilitate access to, the reason for dismissing or demoting the at least one listing to a listing source corresponding to the dismissed or demoted listing (operation 410). In one example, the listing source may be a user or other entity (e.g., a corporate entity, such as a corporation, or another organization) that caused the listing to be placed in the listing database, such as by way of a listing device (e.g., the listing device 140 of FIG. 1).

FIG. 5A depicts an example search device 120 presenting search results 506 (e.g., Listing1, Listing 2, and so on) in response to a search query 502. In this particular example embodiment, the search device 120 may be a smart phone or tablet computer. However, other types of communication or computing devices may serve as the search device 120 in other example embodiments. As shown, the search results 506 are presented to a user of the search device 120 by way of a display component, such as a touchscreen. Further, the search results 506 and other aspects of the user interface of the search device 120 may be provided by way of a web browser executing on the client device 120 that communicates with the search system 102 via a web server (e.g., the web server 222 of FIG. 2), a programmatic application executing on the client device 120 that communicates with the search system 102 by way of an API server (e.g., the API server 220 of FIG. 2), or via other means.

In the example of FIG. 5A, the search query 502 may be a textual query including one or more separate terms or words that are to be matched against, or compared with, listings in a listing database (e.g., the listing database 106 of FIG. 1). In some example embodiments, the search query 502 may be entered using the touchscreen of the search device 120 (e.g., via a displayed virtual keypad), may be selected from a set of previously entered search queries 502 from a dropdown menu (not explicitly shown in FIG. 5A), or the like. In other examples, the search query may be composed using a selection of characteristics, ranges of values, and the like provided in a user interface presented to the user at the search device 120. Moreover, a search based on the search query 502 may be initiated via touching a “submit” virtual button 504 on the touchscreen.

In response to the search initiation, the search results 506 may be displayed. Each listing in the search results 506 may correspond to a particular item, such as an item for sale or purchase, a document, a web site Uniform Resource Locator (URL), and/or any other identifiable item that may be listed in a listing database (e.g., the listing database of FIG. 1) and searched by a user. Each listing may include a title, name, URL, or other identifier for the corresponding item. In some examples, the listings of the search results 506 may be presented in a particular order indicating its relevance to the search query 502, with listings that match more closely to the search query 502 being listed first. In addition, in the case that more listings are to be presented on the search device 120 than may be presented on a single touchscreen, a user of the search device 120 may access the currently undisplayed listings by scrolling through the listings, such as a by way of a scrolling gesture applied to the touchscreen.

The search results 506 may also provide more detailed information (e.g., Information1, Information2, etc.) regarding each corresponding listing of the search results 506. This detailed information may specify various characteristics of its corresponding listing. For example, if the item is an article of commerce that is being presented for sale, the detailed information may include characteristics of potential interest to the user, such as a price, size, color, brand, and/or other parameter associated with the item. If, instead, the item is a document, the detailed information may include an author, date of publication, key terms, general subject matter of the document content, and/or the like. In another example, in which the item is a website page, the detailed information may include a domain or URL of the page, sample text presented at the page, an author of the page, a creation and/or latest modification date of the page, and/or so on. Innumerable other types of items associated with the listings of the search results 506 are also possible.

Also in FIG. 5A, a search results selector/indicator 508 indicates that the search results 506 associated with the most recent search query 502 are being displayed by way of its bold appearance. If a user is instead interested in viewing listings that the user has previously dismissed or demoted, the user may touch a dismissed results selector/indicator 510. In one example, the displayed results may include listings that the user has dismissed or demoted, as recorded in the preference database 110, may include only those listings that the user has dismissed or demoted from the search results 206 of the current search query 502, may include those listings that the user has dismissed or demoted from the search results 506 of the current search query 502 and similar previous search queries, or some other set of dismissed or demoted listings associated with the user. In some examples, each of the listings presented in the dismissed results may include a selector (not shown in FIG. 5B) that, when selected by the user, causes the dismissed or demoted listing to be restored to its prior position within the search results 506.

FIG. 5B depicts the example search device 120 of FIG. 5A while search result feedback is being provided. In this particular example embodiment, a user is selecting Listing3 for dismissal from the search results 506, or demotion to a less prominent position within the search results 506, such as by way of swiping that particular listing on the touchscreen to one side. Other ways of indicating the dismissal or demotion of the listing, such as double-tapping, touch-and-holding, and/or the like, may be utilized in other example embodiments.

In response to the selection from the user, the search device 120 may reveal one or more options for the user to select in conjunction with the selection of the listing to be dismissed or demoted. In this example, the search device 120 may reveal a dismissal selector 512, a demotion selector 514, and a feedback selector 516. When touched, the dismissal selector 512 may cause the dismissal of the selected listing from the search results 506 so that the selected listing does not appear in any portion of the search results 506. Alternatively, touching the demotion selector 514 may cause the selected listing to be demoted within the search results 506, such as by moving the selected listing to the bottom or end of the search results 506.

In an example embodiment, other listings of the search results 506 in addition to the selected listing may be dismissed from, or demoted within, the search results 506 in response to the selection of the dismissal selector 512 or the demotion selector 514, respectively. In one example, the other listings to be dismissed or demoted may be selected based on one or more characteristics or parameters with which the other listings have in common with the selected listing. Further, such characteristics may or may not be listed in the detailed information displayed with each listing in the search results 506. Such characteristics may include, but are not limited to, a seller, manufacturer, size, or color of an article represented by the selected listing; an author, publisher, or subject matter of a document or other published work represented by the selected listing; a website, domain, or author associated with a webpage represented by the selected listing; and/o a listing entity responsible for providing the selected listing. Many other characteristics may be the basis for determining the other listings of the search results 506 based on the selected listing. In some example embodiments, the particular one or more characteristics used to dismiss or demote other listings may be selected by the user, such as by way of a dialog box or other interface element presented to the user via the search device 120.

In some examples in which other listings of the search results 506 are to be demoted, the degree or amount by which each of the other listings are demoted may be positively related to the degree or amount by which the other listings are related to the selected listing. For instance, closely related listings that share a significant number of characteristics with the selected listing may be demoted to a lower level within the search results 506, or may be dismissed from the search results 506 altogether, while less-closely related listings that share a fewer number of characteristics with the selected listing may be less strongly demoted.

As shown in FIG. 5B, selected listings of the search results 506, as well as possibly other listings of the search results 506 that are related in some way to the selected listings, may be removed from the current search results 506. In addition, in response to a subsequent search query 502 that is the same as the current search query 502, or is similar to the current search query 502, may result in those same listings being dismissed or demoted from the associated search results 506. In one example embodiment, the selected listings of the current search results 506 may be stored (e.g., in the preference database 110 of FIG. 1). Thereafter, in response to a subsequent search query 502, the search results 506 corresponding to that search query 502 may be compared against the stored selected listings of the previous search results 506. The listings of those search results 506 corresponding to the subsequent search query 502 that match the stored selected listings may be dismissed or demoted before the presentation of the search results 506 to the user.

In another example, the search query 502 associated with the selected listings of the current search results 506 may also be stored (e.g., in the preference database 110 of FIG. 1) and related to the stored selected listings. Thereafter, in response to a subsequent search query 502 that matches or closely matches the stored search query 502, the stored selected listings associated with the stored search query 502 may then be compared against the search results 506 of a subsequent search query 502, with matching listings of the search results 506 being dismissed or demoted prior to presentation of those search results 506 to the user.

In other example embodiments, other preferences of the user relating to the dismissal or demotion of search results 506 may be stored. For example, the user may provide preference information indicating various types of listings of search results 506 that are not of interest to the user. Such preference information may include, but are not limited to, price, size, color, brand, and/or other parameter associated with an item; an author, date of publication, key terms, and/or general subject matter of a document; and a domain or URL, sample text, author, creation date, and/or latest modification date of a webpage, as well as others.

In some example embodiments, the search device 120 may provide the user with a dialog box or other interface element (not depicted in FIG. 5B) in response to a selection of the dismissal selector 512 and/or the demotion selector 514. The interface element may present a number of potential selections of characteristics upon which the selection of the other listings to be dismissed or demoted may be based, such as the characteristics indicated above. In some examples, the user may select more than one of the characteristics, thus possibly indicating that the other listings to be dismissed or demoted share each of the selected characteristics with the selected listing to be dismissed or demoted. Further, a lack of selection of any of the characteristics may indicate that no other listings in the search results 506 other than the selected listing is to be dismissed or demoted.

In some examples, the characteristics presented in the interface element may depend on the type of item represented by the selected listing. For example, if the item type is an article of clothing, the presented characteristics may include a type of clothing, a manufacturer or seller of the clothing, a size of the clothing, a color of the clothing, a style of the clothing, and the like. If the item type is a document, the presented characteristics may include an author of the document, a publisher of the document, a subject matter of the content of the document, and so on. If, instead, the item type is a webpage, the presented characteristics may include an author of the webpage, a website upon which the webpage is presented, and so forth.

Continuing with FIG. 5B, the feedback selector 516, when selected, may cause the search device 120 to display another dialog box or other interface element (not illustrated in FIG. 5B) that facilitates entry of textual, graphical, or other information input from the user describing, in some level of detail, a reason for dismissing or demoting the selected listing. In one example, the interface element may provide a text box for text entry of the reason; a plurality of radio buttons selectable by the user, with each radio button being associated with a particular reason (e.g., wrong size, wrong color, too expensive, wrong subject matter content, and/or others). The recorded reason may then be presented subsequently to a listing entity (e.g., a seller of an item associated with the selected listing), possibly along with other reasons entered by other users relating to the same listing or other listings provided by the listing entity.

The interface element may also provide a selection for the user as to whether the identity and/or other information identifying the user may be recorded with the reason. Such information may be recorded and subsequently provided to the listing entity to allow the listing entity to contact the user to obtain more information as to why the listing was dismissed or demoted, or to contact the user to indicate that the listing has been changed or modified since the user demoted or dismissed the listing.

FIG. 5C depicts the example search device 120 of FIG. 5A presenting search results subsequent to the search result feedback of FIG. 5B. In this example, with Listing3 being dismissed or demoted, as desired by the user, the selected listing has been either dismissed from the search results 506 entirely or demoted toward the bottom of the search results 506, and thus not presented on the current view of the search results 506. Consequently, subsequent listings, such as Listing4 and Listing5 previously listed on the search results 506, as well as Listing6 not previously presented to the user on the search device 120, are presented in more prominent positions within the search results 506. The user may then be free to select another of the listings of the search results 506 for dismissal or demotion, as well as provide feedback regarding the dismissal or demotion, in the manner described above.

As a result of at least some of the example embodiments disclosed herein, a user receiving search results generated from a search query may tailor those results, as well as subsequent results corresponding to subsequent search queries, by dismissing or demoting selected listings, and possibly listings related to the selected listings in some way. Accordingly, the search results ultimately presented to the user, both now and in the future, may be more in keeping with the type of search results expected by the user in response to search queries. Further, providers of listings may benefit from feedback supplied by the user in conjunction with the dismissing or demoting of listings, thus possibly facilitating modification of current listings, as well as generation of future listings, that may be more readily accepted by the user.

Certain example embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application-Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering example embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In example embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-4 and FIGS. 5A-5C may be implemented in some example embodiments in the context of a machine and an associated software architecture. The sections below describe representative software architectures and machine (e.g., hardware) architectures that are suitable for use with the disclosed example embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here as those of skill in the art can readily understand how to implement the invention in different contexts from the disclosure contained herein.

### Software Architecture

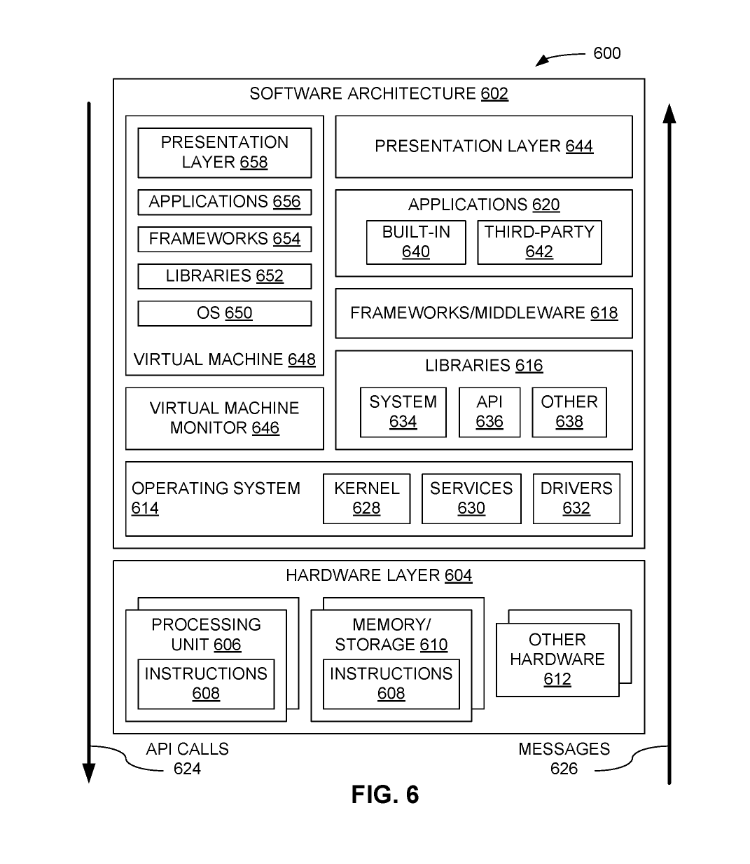

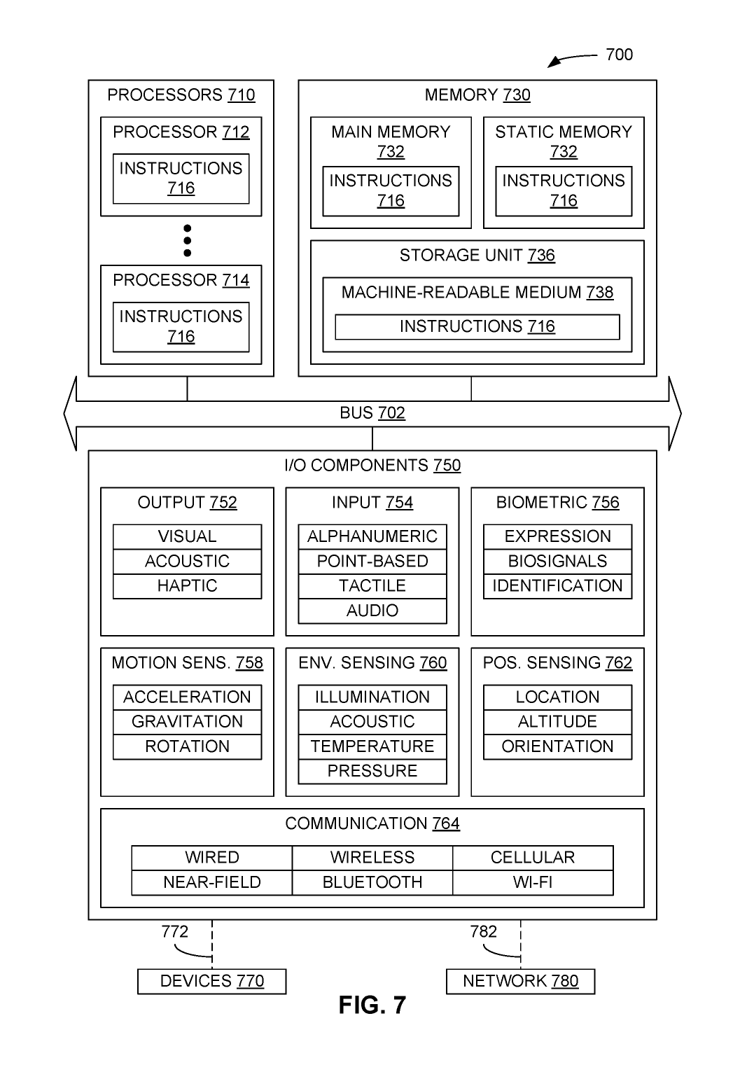

FIG. 6 is a block diagram 600 illustrating a representative software architecture 602, which may be used in conjunction with various hardware architectures herein described. FIG. 6 is merely a non-limiting example of a software architecture and it will be appreciated that many other architectures may be implemented to facilitate the functionality described herein. The software architecture 602 may be executing on hardware such as machine 700 of FIG. 7 that includes, among other things, processors 710, memory 730, and I/O components 750. A representative hardware layer 604 is illustrated and can represent, for example, the machine 700 of FIG. 15. The representative hardware layer 604 comprises one or more processing units 606 having associated executable instructions 608. Executable instructions 608 represent the executable instructions of the software architecture 602, including implementation of the modules and other components associated with the search system 102 of FIG. 1, as well as the methods 300 and 400 of FIGS. 3 and 4. Hardware layer 604 also includes memory and/or storage modules 610, which also have executable instructions 608. Hardware layer 604 may also comprise other hardware as indicated by 612 which represents any other hardware of the hardware layer 604, such as the other hardware illustrated as part of machine 700.

In the example architecture of FIG. 6, the software architecture 602 may be conceptualized as a stack of layers where each layer provides particular functionality. For example, the software 602 may include layers such as an operating system 614, libraries 616, frameworks/middleware 618, applications 620 and presentation layer 644. Operationally, the applications 620 and/or other components within the layers may invoke application programming interface (API) calls 624 through the software stack and receive a response, returned values, and so forth illustrated as messages 626 in response to the API calls 624. The layers illustrated are representative in nature and not all software architectures have all layers. For example, some mobile or special purpose operating systems may not provide a frameworks/middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) may provide a higher-level common infrastructure that may be utilized by the applications 620 and/or other software components/modules. For example, the frameworks 618 may provide various graphic user interface (GUI) functions, high-level resource management, high-level location services, and so forth. The frameworks 618 may provide a broad spectrum of other APIs that may be utilized by the applications 620 and/or other software components/modules, some of which may be specific to a particular operating system or platform.

The applications 620 may include built-in applications 640 and/or third party applications 642. Examples of representative built-in applications 640 may include, but are not limited to, a contacts application, a browser application, a book reader application, a location application, a media application, a messaging application, and/or a game application. Third party applications 642 may include any of the built-in applications as well as a broad assortment of other applications. In a specific example, the third party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 642 may invoke the API calls 624 provided by the mobile operating system such as operating system 614 to facilitate functionality described herein.

The applications 620 may utilize built-in operating system functions (e.g., kernel 628, services 630 and/or drivers 632), libraries (e.g., system 634, APIs 636, and other libraries 638), and frameworks/middleware 618 to create user interfaces to interact with users of the system. Alternatively, or additionally, in some systems, interactions with a user may occur through a presentation layer, such as presentation layer 644. In these systems, the application/module “logic” can be separated from the aspects of the application/module that interact with a user.

Some software architectures utilize virtual machines. In the example of FIG. 6, this is illustrated by virtual machine 648. A virtual machine creates a software environment where applications/modules can execute as if they were executing on a hardware machine (such as the machine of FIG. 7, for example). A virtual machine is hosted by a host operating system (operating system 614 in FIG. 15) and typically, although not always, has a virtual machine monitor 646, which manages the operation of the virtual machine as well as the interface with the host operating system (i.e., operating system 614). A software architecture executes within the virtual machine such as an operating system 650, libraries 652, frameworks/middleware 654, applications 656 and/or presentation layer 658. These layers of software architecture executing within the virtual machine 648 can be the same as corresponding layers previously described or may be different.

### Example Machine Architecture and Machine-Readable Medium

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions may cause the machine to execute the flow diagrams of FIGS. 3 and 4. Additionally, or alternatively, the instructions may implement the various modules of the search system 102 of FIG. 1, and so forth. The instructions transform the general, non-programmed machine into a particular machine programmed to carry out the described and illustrated functions in the manner described. In alternative example embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), or any machine capable of executing the instructions 716, sequentially or otherwise, that specify actions to be taken by machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 712 and processor 714 that may execute instructions 716. The term “processor” is intended to include multi-core processor that may comprise two or more independent processors (sometimes referred to as “cores”) that may execute instructions contemporaneously. Although FIG. 7 shows multiple processors, the machine 700 may include a single processor with a single core, a single processor with multiple cores (e.g., a multi-core process), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of processors 710 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Electrically Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of example embodiments of the present disclosure. Such example embodiments of the present subject matter may be referred to herein, individually or collectively, by the term “invention” merely for convenience and without intending to voluntarily limit the scope of this application to any single disclosure or inventive concept if more than one is, in fact, disclosed.

The example embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A search system comprising:
a listing database comprising a plurality of listings;
a search engine configured to generate first search results in response to a first search query, the first search results comprising one or more of the plurality of listings;
a search results modifier configured to receive a selection of a first listing of the first search results, the selection of the first listing indicating a lack of interest in the first listing; and
a preference database configured to store an identifier for the first listing in response to the selection of the first listing;
the search engine configured to generate second search results in response to a second search query subsequent to the first search query, the second search results comprising the first listing; and
the search results modifier configured to modify the second search results to less prominently display the first listing in the second search results based on the identifier for the first listing stored in the preference database, and to provide the modified second search results for display.

2. The search system of claim 1, the search results modifier configured to modify the second search results to less prominently display the first listing by demoting the first listing in the second search results to a less prominent position within the second search results.

3. The search system of claim 1, the search results modifier configured to modify the second search results to less prominently display the first listing by removing the first listing from the second search results.

4. The search system of claim 1, the search results modifier configured to modify the first search results to less prominently display the first listing in the first search results based on the selection of the first listing, and to provide the modified first search results for display.

5. The search system of claim 1, the search results modifier configured to less prominently display a second listing of the plurality of listings based on a characteristic of the second listing corresponding to a characteristic of the first listing.

6. The search system of claim 5, the search results modifier configured to less prominently display the second listing by an amount related to the correspondence of the characteristic of the second listing to the characteristic of the first listing.

7. The search system of claim 5, the search results modifier configured to receive a selection of the characteristic.

8. The search system of claim 5, the characteristic comprising at least one of price, size, color, brand, author, key term, domain, universal resource locator, author, creation date, modification date, or publication date.

9. The search system of claim 1, the preference database configured to store the first search query in association with the identifier for the first listing, and the search results modifier configured to less prominently display a second listing of the second search results based on the second search query corresponding to the first search query, and based on the storing of the first search query in association with the identifier for the first listing.

10. The search system of claim 1, the preference database further comprising at least one preference indicator indicating a listing characteristic, and the search results modifier configured to less prominently display a second listing of the second search results different from the first listing based on the second listing exhibiting the listing characteristic.

11. The search system of claim 1, further comprising:
a listing feedback processor configured to receive feedback information corresponding to the first listing, and to provide the feedback information to an entity that created the first listing, the feedback information comprising a reason for the selection of the first listing.

12. The search system of claim 1, the plurality of listings comprising a listing for each of a plurality of articles for sale.

13. The search system of claim 1, the plurality of listings comprising a listing for each of a plurality of documents.

14. The search system of claim 1, the plurality of listings comprising a listing for each of a plurality of webpages.

15. A method comprising:
generating first search results in response to a first search query, the first search results comprising one or more of a plurality of listings;
receiving a selection of a first listing of the first search results, the selection of the first listing indicating a lack of interest in the first listing;
storing an identifier for the first listing in response to receiving the selection of the first listing;
generating second search results in response to a second search query subsequent to the first search query, the second search results comprising the first listing;
modifying, using at least one hardware processor of a machine, the second search results to less prominently display the first listing in the second search results based on the stored identifier for the first listing; and
providing the modified second search results for display.

16. The method of claim 15, the modifying of the second search results comprising demoting the first listing in the second search results to a less prominent position within the second search results or removing the first listing from the second search results.

17. The method of claim 16, further comprising:
receiving feedback information corresponding to the first listing, the feedback information comprising a reason for the selection of the first listing; and
providing the feedback information to an entity that created the first listing.

18. A system comprising:
a listing database comprising a plurality of listings;
at least one hardware processor; and
memory having stored thereon instructions that, when executed by the at least one hardware processor, cause the system to perform operations comprising:
generating first search results in response to a first search query, the first search results comprising one or more of the plurality of listings;
receiving a selection of a first listing of the first search results, the selection of the first listing indicating a lack of interest in the first listing;
storing an identifier for the first listing in response to receiving the selection of the first listing;
generating second search results in response to a second search query subsequent to the first search query, the second search results comprising the first listing;
modifying the second search results to less prominently display the first listing in the second search results based on the stored identifier for the first listing; and
providing the modified second search results for display.

19. The system of claim 18, the operations further comprising:
modifying the first search results to less prominently display the first listing in the first search results based on the selection of the first listing; and
providing the modified first search results for display.

20. The system of claim 18, the operations further comprising:
less prominently displaying a second listing of the plurality of listings based on a characteristic of the second listing corresponding to a characteristic of the first listing.
